(19) United States
(12) Patent Application Publication
(10) Pub. No.: US 2020/0227190 A1
(43) Pub. Date: Jul. 16, 2020

(54) BI-STABLE ELECTROMAGNET

(71) Applicant: Jiayi ZHU, (US)

(72) Inventor: Jiayi ZHU, Shanghai (CN)

(21) Appl. No.: 16/389,874

(22) Filed: Apr. 19, 2019

Related U.S. Application Data
(63) Continuation of application No. PCT/CN2019/073993, filed on Jan. 30, 2019.

(30) Foreign Application Priority Data
Jan. 10, 2019 (CN) 201910022956.4

(51) Int. Cl. H01F 7/20

(52) U.S. Cl. CPC H01F 7/20

(57) ABSTRACT

A bi-stable electromagnet, comprising block permanent magnets, a coil package, a reversible magnet, a magnetizer and a casing, wherein the reversible magnet is disposed in an inner cavity on the upper half part of the casing; the peripheral side of the reversible magnet is coated with the coil package; the upper and lower surfaces of the reversible magnet have different magnetic poles; a magnetic axis of the reversible magnet is superposed with a geometric center axis of the reversible magnet; the upper surface of the reversible magnet is attached to the casing; the magnetizer is disposed in an inner cavity of the lower half part of the casing; the lower surface of the reversible magnet is attached to the magnetizer.

### TECHNICAL FIELD

The present invention relates to the technical field of electromagnets, in particular to a bi-stable electromagnet.

### BACKGROUND ART

An electromagnet is an important actuator in industrial control. The electromagnet is an electromagnetic conversion device. A conductive winding that matches a power of an iron core is wound on the outside of the iron core. Such a coil to which a current is introduced is magnetic like a magnet to make the iron core easier to magnetize. The electromagnet is often made of soft iron or silicon steel material that degausses fast, such that the electromagnet is magnetic when powered on and non-magnetic when powered off, that is, the electromagnet generates the magnetism when powered on and losses the magnetism when powered off. There is also a power-losing type electromagnet which loses the magnetism when powered on and generates the magnetism when powered off. Both of these electromagnets have a common feature, that is, there is only one stable state, that is, a monostable state, and the state exhibited under the powered-on condition is an unstable state.

### SUMMARY OF THE INVENTION

An objective of the present invention aims to make an improvement based on the prior art and to provide a bi-stable electromagnet having a novel structure. The bi-stable electromagnet can achieve the following purpose: once the power-on trigger is completed instantaneously and the state of a selected electromagnet (magnetic or non-magnetic) is established, no continuous power supply is required. That is to say, once the state (magnetic or non-magnetic) of the electromagnet is determined by an operation, there is no need to provide any energy from the outside to maintain this state, and this state will not be easily broken and can be maintained indefinitely unless you re-select another state and determine it by an operation.

To fulfill said objective, a bi-stable electromagnet is designed, comprising block permanent magnets, a coil package, a reversible magnet, a magnetizer and a casing, wherein the reversible magnet is disposed in an inner cavity on the upper half part of the casing; the peripheral side of the reversible magnet is coated with the coil package; a magnetic axis of the reversible magnet is superposed with a geometric center axis of the reversible magnet; the upper and lower surfaces of the reversible magnet have different magnetic poles; the upper surface of the reversible magnet is attached to the casing; the magnetizer is disposed in an inner cavity of the lower half part of the casing; the lower surface of the reversible magnet is attached to the magnetizer; a plurality of independent block permanent magnets which are uniformly arranged along the circumference of the magnetizer is disposed between the magnetizer and the inner wall of the inner cavity on the lower half part of the casing; the polarity arrangement of adjacent block permanent magnets remains the same, i.e., the sides of the adjacent block permanent magnet close to the casing are one poles and the sides thereof close to the magnetizer are the other poles; and the magnetic axis points to the center of the circumference of the magnetizer.

The casing is made of a permeability magnetic material.

The power-on triggering process is an instantaneous process in which a current is passed through a coil to positively or reversely magnetize the reversible magnet. Once the reversible magnet is magnetized, its magnetic field intensity will be stored in the casing.

A gap in which a plurality of block permanent magnets is placed is arranged between the casing and the magnetizer, and the distribution and quantity of the block permanent magnets are based on the magnetic field balance. The magnetic field balance refers to the intensity of the magnetic field formed by the magnetization of the reversible magnet and the intensity of the magnetic field formed by all of the plurality of block permanent magnets, both of which are equivalent to each other, thereby achieving the magnetic field balance.

The bi-stable electromagnet designed by the present invention has two stable states, i.e., a magnetic stable state and a non-magnetic stable state. Once the determination of power-on trigger of a state is selected, no continuous power supply is required. This state can be maintained indefinitely and cannot be easily broken. This state cannot be reversed unless you choose the determination of power-on trigger of another state. That is, a non-magnetic state is changed into a magnetic state or vice versa. This process is to magnetize the previous reversible magnet with a reverse current, such that magnetic poles of the reversible magnet pole are reversed. The reversal of the two states is completed instantaneously, without the need for continuous power supply, and therefore does not cause continuous heating and energy consumption of the bi-stable electromagnet. It can thus be seen that the bi-stable electromagnet is an electro-magnetic conversion device which is energy-saving, and reliable and flexible in control.

### BRIEF DESCRIPTION OF THE DRAWINGS

FIG. 1 is a bottom view of the present invention.

FIG. 2 is a main view of the present invention.

In drawings, the reference symbols represent the following components: 1—block permanent magnet; 2—coil package; 3—reversible magnet; 4—magnetizer; 5—casing.

### DETAILED DESCRIPTION OF THE PREFERRED EMBODIMENTS

The technical solution of the present invention will be further clarified with reference to the accompanying drawings and embodiments, and will be apparent to those skilled in the art.

A bi-stable electromagnet structurally comprises block permanent magnets 1, a coil package 2, a reversible magnet 3, a magnetizer 4, and a casing 5. The casing 5 is also made of a permeability magnetic material.

As shown in FIG. 2, firstly, the reversible magnet 3 is disposed in an inner cavity on the upper half part of the casing 5. The peripheral side of the reversible magnet 3 is coated with the coil package 2. A magnetic axis of the reversible magnet is superposed with a geometric center axis of the reversible magnet. The upper and lower surfaces of the reversible magnet 3 have different magnetic poles. The upper surface of the reversible magnet 3 is attached to the casing 5.

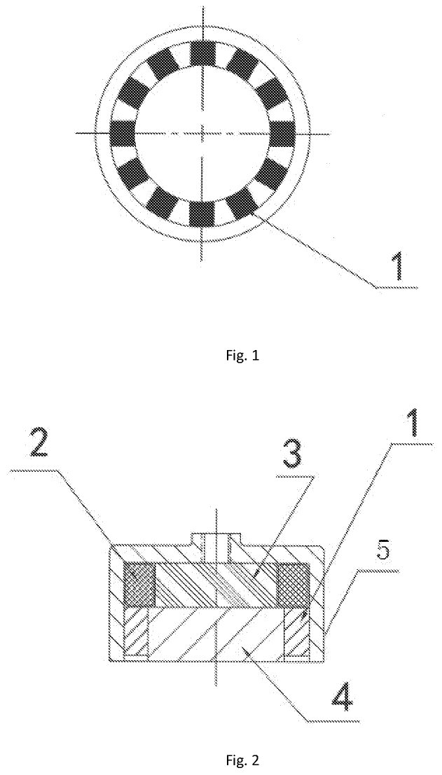

As shown in FIG. 1, the magnetizer 4 is disposed in an inner cavity of the lower half part of the casing 5. The lower surface of the reversible magnet 3 is attached to the magnetizer 4. A gap in which the plurality of block permanent magnets 1 is placed is arranged between the casing 5 and the magnetizer 4. A plurality of independent block permanent magnets 1 is uniformly arranged along the circumference of the magnetizer 4. The polarity arrangement of adjacent block permanent magnets 1 remains the same. The magnetic axis points to the center of the circumference of the magnetizer 4, i.e., the sides of the adjacent block permanent magnet close to the casing are one poles and the sides thereof close to the magnetizer are the other poles. The distribution and quantity of the block permanent magnets are based on the magnetic field balance.

There is a certain proportional relationship between the size of each permanent magnet and the size of the reversible magnet. Influenced by the magnetic field intensity of the permanent magnets and the magnetization intensity of the reversible magnet, when the volume and the magnetic field intensity of the reversible magnet are fixed, the size and distribution of the permanent magnets are determined. Theoretically, it is feasible but actually requires an infinite number of combinations in shapes and volumes to achieve a balance between a magnetic state and a non-magnetic state, otherwise there will be residual magnetism in the non-magnetic state. The bi-stable electromagnet of the present invention solves the problem of the balance between the magnetic state and the non-magnetic state by increasing or decreasing the number of distributed permanent magnets, thereby making the process of the present invention simple and efficient.

### Embodiment 1

The magnetic state operation is selected: the power-on trigger is determined instantaneously, and the process is as follows:

the polarity arrangement of adjacent block permanent magnets 1 remains the same; the magnetic axis points to the center of the circumference of the magnetizer 4, i.e., the sides of the adjacent block permanent magnets close to the casing 5 are N poles and the sides thereof close to the magnetizer 4 are S poles; a current is triggered by powering on to magnetize the reversible magnet 3 through the coil 2 and to obtain a magnetic field; the upper surface of the reversible magnet 3 is N pole, and the lower surface thereof is S pole; the upper surface of the reversible magnet 3 is attached to the casing and is the N pole for conducting the casing 5; the lower surface of the reversible magnet 3 is attached to the magnetizer 4 and is the S pole for conducting the magnetizer 4; at this time, the magnetic field formed by the reversible magnet and the magnetic field formed by the block permanent magnets are superimposed to generate a strong magnetic force, and the magnetic stable state is formed, which has an attraction to the permeability magnetic material.

### Embodiment 2

The non-magnetic state operation is selected: the power-on trigger is determined instantaneously, and the process is as follows:

the polarity arrangement of adjacent block permanent magnets 1 remains the same; the magnetic axis points to the center of the circumference of the magnetizer 4, i.e., the sides of the adjacent block permanent magnets close to the casing are N poles and the sides thereof close to the magnetizer 4 are S poles; a reverse current is triggered by powering on to magnetize the reversible magnet 3 through the coil 2 and to obtain a reverse magnetic field;

the upper surface of the reversible magnet 3 becomes S pole, and the lower surface thereof becomes N pole; the upper surface of the reversible magnet 3 is attached to the casing 5 and is the S pole for conducting the casing 5; the lower surface of the reversible magnet 3 is attached to the magnetizer 4 and is the N pole for conducting the magnetizer 4; at this time, the magnetic field formed by the reversible magnet and the magnetic field formed by the block permanent magnets attract with each other to form self-closure, and the non-magnetic stable state is formed, which has no attraction to the permeability magnetic material.

What is claimed is:

1. A bi-stable electromagnet, comprising block permanent magnets (1), a coil package (2), a reversible magnet (3), a magnetizer (4) and a casing (5), wherein the reversible magnet (3) is disposed in an inner cavity on the upper half part of the casing (5); the peripheral side of the reversible magnet (3) is coated with the coil package (2); a magnetic axis of the reversible magnet is superposed with a geometric center axis of the reversible magnet; the upper and lower surfaces of the reversible magnet (3) are different magnetic poles; the upper surface of the reversible magnet (3) is attached to the casing (5); the magnetizer (4) is disposed in an inner cavity of the lower half part of the casing (5); the lower surface of the reversible magnet (3) is attached to the magnetizer (4); a plurality of independent block permanent magnets (1) which are uniformly arranged along the circumference of the magnetizer (4) is disposed between the magnetizer (4) and the inner wall of the inner cavity on the lower half part of the casing (5); the polarity arrangement of adjacent block permanent magnets remains the same, i.e., the sides of the adjacent block permanent magnet close to the casing are one poles and the sides thereof close to the magnetizer are the other poles; and the magnetic axis points to the center of the circumference of the magnetizer (4).

2. The bi-stable electromagnet according to claim 1, wherein the casing is made of a permeability magnetic material.

3. The bi-stable electromagnet according to claim 1, wherein a gap in which a plurality of block permanent magnets is placed is arranged between the casing (5) and the magnetizer (4), and the distribution and quantity of the block permanent magnets are based on the magnetic field balance.
